(19) United States
(12) Patent Application Publication
(10) Pub. No.: US 2015/0177688 A1
(43) Pub. Date: Jun. 25, 2015

(54) APPARATUS FOR COPYING A HOLOGRAM

(71) Applicants: Milan Momcilo Popovich, Leicester (GB); Jonathan David Waldern, Los Altos Hills, CA (US)

(72) Inventors: Milan Momcilo Popovich, Leicester (GB); Jonathan David Waldern, Los Altos Hills, CA (US)

(21) Appl. No.: 14/409,317

(22) PCT Filed: Jun. 17, 2013
(86) PCT No.: PCT/GB2013/000273

§ 371 Date: Dec. 18, 2014

Related U.S. Application Data
(60) Provisional application No. 61/690,014, filed on Jun. 18, 2012.

(51) Int. Cl. G03H 1/20

(52) U.S. Cl. CPC G03H 1/20

(57) ABSTRACT

A holographic recording apparatus having a source of illumination, a master hologram containing at least one hologram lamina overlaying, a copy substrate containing a holographic recording medium, and a voltage generator for applied a voltage across at least one of the master hologram and the copy substrate. The master hologram diffracts the illumination light into zero order light and diffracted light which interfere in the copy substrate to form a copy of the master hologram. The source of illumination is applied for a predefined exposure time during which the voltage varies the refractive index modulation of at least one of the master hologram and the copy hologram.

### CROSS REFERENCE TO RELATED APPLICATIONS

This application claims priority from U.S. Provisional Application Ser. No. 61/690,014 with filing date 18 Jun. 2012 entitled ELECTRICALLY CONTROLLABLE MASTER HOLOGRAM FOR CONTACT COPYING, which is hereby incorporated by reference in its entirety.

The following patent applications are incorporated by reference herein in their entireties:
U.S. Provisional Patent Application No. 61/687,436 with filing date 25 Apr. 12 entitled WIDE ANGLE COLOUR HEAD MOUNTED DISPLAY;
U.S. Provisional Patent Application No. 61/689,907 with filing date 25 Apr. 12 entitled HOLOGRAPHIC HEAD MOUNTED DISLAY WITH IMPROVED IMAGE UNIFORMITY;
U.S. Provisional Application No. 61/796,632 with filing date 16 Oct. 2012 entitled TRANSPARENT DISPLAYS BASED ON HOLOGRAPHIC SUBSTRATE GUIDED OPTICS;
U.S. Provisional Application No. 61/849,853 with filing date 4 Feb. 2013 entitled TRANSPARENT WAVEGUIDE DISPLAY;
PCT Application No.: US2008/001909, with International Filing Date: 22 Jul. 2008, entitled LASER ILLUMINATION DEVICE;
PCT Application No.: US2006/043938, entitled METHOD AND APPARATUS FOR PROVIDING A TRANSPARENT DISPLAY;
PCT Application No.: PCT/GB2010/001982 entitled COMPACT EDGE ILLUMINATED EYEGLASS DISPLAY;
PCT Application No.: PCT/GB2012/000680, entitled IMPROVEMENTS TO HOLOGRAPHIC POLYMER DISPERSED LIQUID CRYSTAL MATERIALS AND DEVICES;
PCT Application No.: PCT/GB2010/000835 entitled COMPACT HOLOGRAPHIC EDGE ILLUMINATED EYEGLASS DISPLAY;
U.S. Pat. No. 6,115,152 entitled HOLOGRAPHIC ILLUMINATION SYSTEM; and
U.S. Pat. No.: 6,323,970 by Popovich with filing date 26 Sep. 2000 entitled METHOD OF PRODUCING SWITCHABLE HOLOGRAMS.

### BACKGROUND OF THE INVENTION

The present invention relates to holography and more particularly to an improved method for replicating holograms using electrical control of refractive index modulation.

Replication of holograms is usually carried out by preparing a master hologram of the desired prescription which is then copied into another holographic recording material using a contact process. The master is usually made using a classical two-beam holographic recording system comprising an object beam and a reference beam. However, the master could itself be a copy of another master. In the case of a transmission hologram the copying process is based on interfering the diffracted and zero order beams produced by master to form a grating within the copy hologram material. Subject to processing variations such as shrinkage the holographic pattern or grating formed in the copy should be identical to the one in the master. This procedure may be used in mass production roll-to-roll processes. The principles of holographic replication and industrial processes for the mass production of holograms are well documented in the literature.

The optical design benefits of diffractive optical elements (DOEs) are well known, including unique and efficient form factors and the ability to encode complex optical functions such as optical power and diffusion into thin layers. Bragg gratings (also commonly termed volume phase grating or holograms), which offer the highest diffraction efficiencies, have been widely used in devices such as Head Up Displays. An important class of Bragg grating devices is known as a Switchable Bragg Grating (SBG). An SBG is a diffractive device formed by recording a volume phase grating, or hologram, in a polymer dispersed liquid crystal (PDLC) mixture. Typically, SBG devices are fabricated by first placing a thin film of a mixture of photopolymerizable monomers and liquid crystal material between parallel glass plates or substrates. Techniques for making and filling glass cells are well known in the liquid crystal display industry. One or both glass substrates support electrodes, typically transparent indium tin oxide films, for applying an electric field across the PDLC layer. A volume phase grating is then recorded by illuminating the liquid material with two mutually coherent laser beams, which interfere to form the desired grating structure. During the recording process, the monomers polymerize and the HPDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the PDLC layer. When an electric field is applied to the hologram via transparent electrodes, the natural orientation of the LC droplets is changed causing the refractive index modulation of the fringes to reduce and the hologram diffraction efficiency to drop to very low levels. Note that the diffraction efficiency of the device can be adjusted, by means of the applied voltage, over a continuous range from near 100% efficiency with no voltage applied to essentially zero efficiency with a sufficiently high voltage applied.

SBGs may be used to provide transmission or reflection gratings for free space applications. SBGs may be implemented as waveguide devices in which the HPDLC forms either the waveguide core or an evanescently coupled layer in proximity to the waveguide. In one particular configuration to be referred to here as Substrate Guided Optics (SGO) the parallel glass plates used to form the HPDLC cell provide a total internal reflection (FIR) light guiding structure. Light is “coupled” out of the SBG when the switchable grating diffracts the light at an angle beyond the TIR condition. SGOs are currently of interest in a range of display and sensor applications. Although much of the earlier work on HPDLC has been directed at reflection holograms transmission devices are proving to be much more versatile as optical system building blocks and tend to be much easier to fabricate.

Typically, the HPDLC used in SBGs comprise liquid crystal (LC), monomers, photoinitiator dyes, and coinitiators. The mixture frequently includes a surfactant. The patent and scientific literature contains many examples of material systems and processes that may be used to fabricate SBGs. Two fundamental patents are: U.S. Pat. No. 5,942,157 by Sutherland, and U.S. Pat. No. 5,751,452 by Tanaka et al. both filings describe monomer and liquid crystal material combinations suitable for fabricating SBG devices.

One of the known attributes of transmission SBGs is that the LC molecules tend to align normal to the grating fringe planes. The effect of the LC molecule alignment is that transmission SBGs efficiently diffract P polarized light (ie light with the polarization vector in the plane of incidence) but have nearly zero diffraction efficiency for S polarized light (ie light with the polarization vector normal to the plane of incidence. Transmission SBGs may not be used at near-grazing incidence as the diffraction efficiency of any grating for P polarization falls to zero when the included angle between the incident and reflected light is small. A glass light guide in air will propagate light by total internal reflection if the internal incidence angle is greater than about 42 degrees. Thus the invention may be implemented using transmission SBGs if the internal incidence angles are in the range of 42 to about 70 degrees, in which case the light extracted from the light guide by the gratings will be predominantly p-polarized.

Normally SBGs diffract when no voltage is applied and are switching into their optically passive state when a voltage is application other times. However SBGs can be designed to operate in reverse mode such that they diffract when a voltage is applied and remain optically passive at all other times. Methods for fabricating reverse mode SBGs are disclosed in a U.S. Provisional Patent Application No. 61/573,066. with filing date 24 Aug. 2011 by the present inventors entitled IMPROVEMENTS TO HOLOGRAPHIC POLYMER DISPERSED LIQUID CRYSTAL MATERIALS AND which is incorporated by reference herein in its entirety. The same reference also discloses how SBGs may be fabricated using flexible plastic substrates to provide the benefits of improved ruggedness, reduce weight and safety in near eye applications.

The present invention is motivated by the requirement to replicate SBGs for demanding applications such as wearable displays which typically demand tight control of the diffraction efficiency and geometrical optical characteristics of the replicated holograms. In particular there is a need for precise control of the intensities of the diffracted and zero order beams. Currently available holographic mastering process suffer from the problem that the relative intensities of the diffracted and zero orders cannot be controlled to better than ±5%.

The inventors have discovered that a perfect copy can be made if the master hologram is “over-modulated” by a small amount. Over-modulation in this context means that the refractive index modulation of the hologram is a little above that required to achieve the desired beam ratio. The next step is to separately attenuate the master beams to bring them to the desired ratio. Typically we require 50/50 or 1:1. However, the inventors have found that making a perfect master with the appropriate level of over-modulation, which is typically 5-10%, is very difficult in practice. To the best of the inventors' knowledge the required levels of index modulation control have not been achieved using conventional holographic recording processes using currently available holographic recording materials such as photopolymers and Photo Thermo Refractive (PTR) materials.

There is a requirement for a master hologram with more precisely controllable refractive index modulation for use in holographic replication processes.

### SUMMARY OF THE INVENTION

There is provided a master hologram with more precisely controllable refractive index modulation for use in holographic replication processes. The objects of the invention are achieved in a first embodiment in which there is provided a holographic recording apparatus comprising: a source of illumination; a master hologram containing at least one hologram lamina overlaying; a copy substrate containing a holographic recording medium; and a voltage generator for applied a voltage across at least one of said master hologram and said copy substrate. The master hologram diffracts the illumination light into zero order light and diffracted light which interfere in the copy substrate to form a copy of the master hologram. The source of illumination is applied for a predefined exposure time during which the voltage varies the refractive index modulation of at least one of the master hologram and the copy hologram.

In one embodiment of the invention the applied voltage produces a spatial variation of the refractive index modulation.

In one embodiment of the invention the master hologram is one of a photo thermal refractive or photopolymer, a forward mode SBG or a reverse mode SBG.

In one embodiment of the invention the master hologram is a SBG comprising transparent plates to which electrodes coupled to the voltage generator have been applied, the plates sandwiching a layer containing HPDLC material components.

In one embodiment of the invention the master hologram comprises a multiplicity of electrically addressable SBG lamina.

In one embodiment of the invention the at least one hologram lamina has a grating vector selected from a predefined set of grating vectors.

In one embodiment of the invention the at least one hologram lamina has a grating vector selected from a predefined set of randomly orientated grating vectors

In one embodiment of the invention the at least one hologram lamina has a spatially varying grating vector.

In one embodiment of the invention the holographic recording medium comprises HPDLC material components for forming one of a forward mode SBG or a reverse mode SBG.

In one embodiment of the invention the zero order light and diffracted light have power substantially in the ratio of 1:1.

In one embodiment of the invention the copy substrate is fabricated from optical plastic.

In one embodiment of the invention the master hologram and the copy substrate are separated by an air gap.

In one embodiment of the invention the master hologram and the copy substrate are in contact.

In one embodiment of the invention the copy substrate forms part of a mechanically translatable continuous lamina.

A more complete understanding of the invention can be obtained by considering the following detailed description in conjunction with the accompanying drawings, wherein like index numerals indicate like parts. For purposes of clarity, details relating to technical material that is known in the technical fields related to the invention have not been described in detail.

### BRIEF DESCRIPTION OF THE DRAWINGS

FIG. 1 is a schematic side elevation view of a master hologram in one embodiment of the invention.

FIG. 2 is a schematic side elevation view of a master hologram and a copy substrate in one embodiment of the invention.

FIG. 3 is a schematic side elevation view illustrating a first operational state of a master hologram comprising an array of SBG elements in one embodiment of the invention.

FIG. 4 is a schematic side elevation view illustrating a second operational state of a master hologram comprising an array of SBG elements in one embodiment of the invention.

FIG. 5 is a schematic side elevation view illustrating the use of a master hologram according to the principles of the invention in a roll to roll industrial process.

FIG. 6 is a schematic side elevation view of a holographic copying apparatus in one embodiment of the invention in which voltages are applied to the master hologram and the copy substrate during the recording process.

### DETAILED DESCRIPTION OF THE INVENTION

The invention will now be further described by way of example only with reference to the accompanying drawings. It will apparent to those skilled in the art that the present invention may be practiced with some or all of the present invention as disclosed in the following description. For the purposes of explaining the invention well-known features of optical technology known to those skilled in the art of optical design and visual displays have been omitted or simplified in order not to obscure the basic principles of the invention. Unless otherwise stated the term “on-axis” in relation to a ray or a beam direction refers to propagation parallel to an axis normal to the surfaces of the optical components described in relation to the invention. In the following description the terms light, ray, beam and direction may be used interchangeably and in association with each other to indicate the direction of propagation of light energy along rectilinear trajectories. Parts of the following description will be presented using terminology commonly employed by those skilled in the art of optical design. The term “grating” may be used to describe a hologram. It should also be noted that in the following description of the invention repeated usage of the phrase “in one embodiment” does not necessarily refer to the same embodiment.

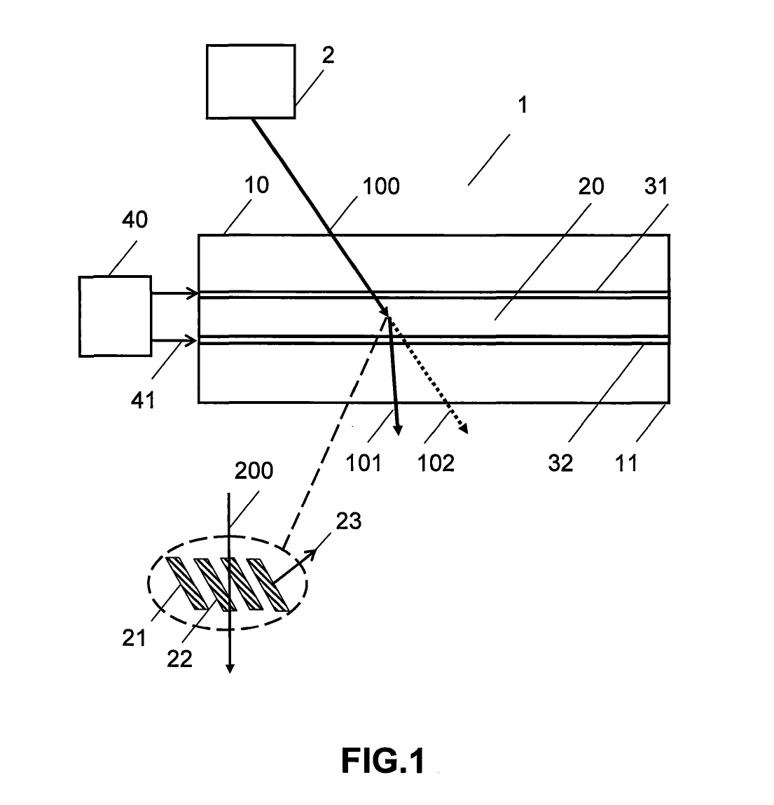

FIG. 1 is a schematic illustrate of a SBG master hologram 1 comprising a SBG layer 20 sandwiched by transparent substrates 10,11. Transparent ITO electrodes 31.32 are applied to opposing faces of the substrates. The electrodes are connected to a voltage source 40 via the electrical circuits generally indicated by 41. Incident light 100 from a source 2 (typically a laser) is diffracted by the SBG to give a diffracted beam in the direction 101 and a zero order beam in the direction 102. To simplify the explanation of the invention the effects of refraction at the optical media interfaces within the master hologram are not illustrated. Referring to the detail of the grating highlighted by the dashed lines we see that it comprised of alternate high and low refractive index fringes such as 21,22 typically disposed at a slant angle to the normal to the master hologram. The grating vector which according to the conventions of grating theory is normal to the grating fringes is indicated by 23. The voltage source produces and electric field substantially normal the grating as indicated by 200. The effect of the electric field is to change the refractive index modulation as explained above, which in turn changes the diffraction efficiency. Hence by suitable voltage control it is possible to vary the ratio of the diffracted to zero order beam intensities.

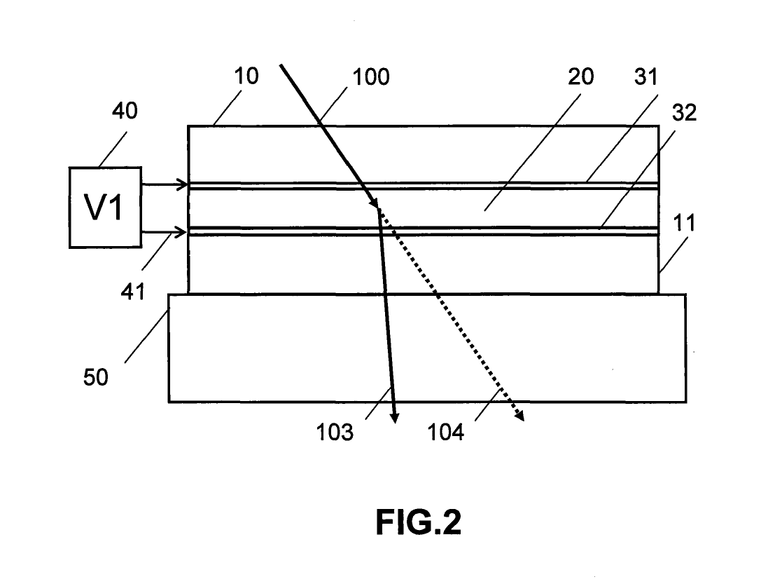

FIG. 2 is a schematic cross sectional view of the master hologram of FIG. 1 in contact with (or in close proximity to) an optical substrate containing a holographic recording material 50 into which the master hologram will be copied. The grating is copied by intersecting the diffracted and zero order beams 103,104 from the master hologram. The relative intensities of the two recording beams are determined by the voltage V1.

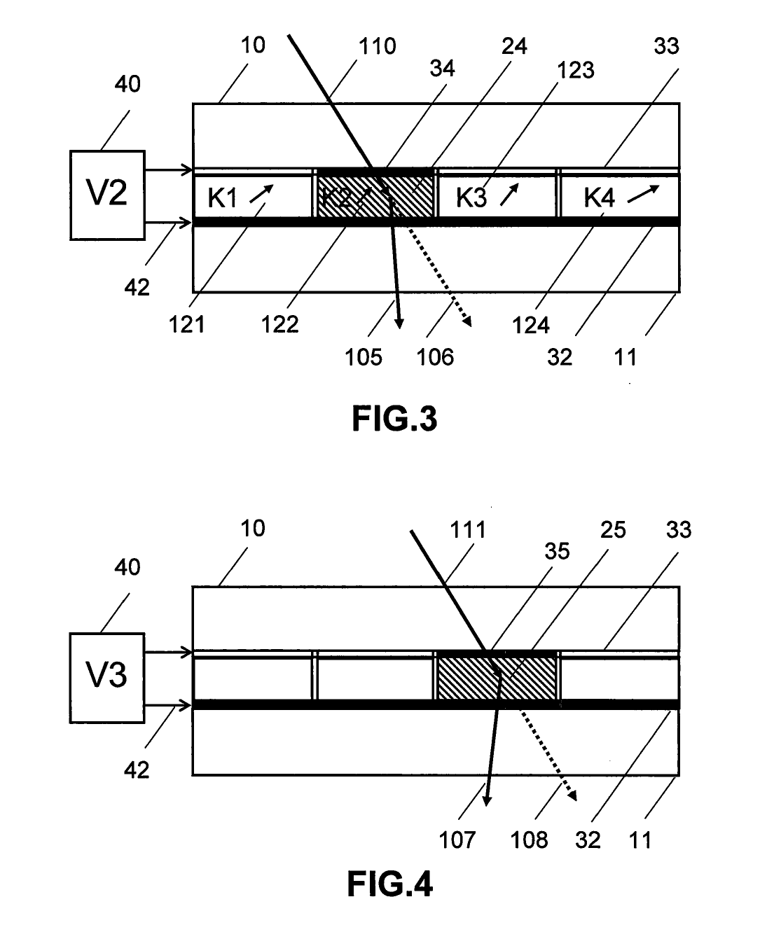

In one embodiment of the invention the master hologram comprises an array of selectively switching SBG elements. In the examples shown in the schematic illustration of FIGS. 3-4 the SBG array comprises elements such as 34 and 35. Each element is characterised by a grating vector such as the ones indicated by the arrows labelled K1-K4 and referenced by numerals 121-124. The grating vectors may have any orientation. Voltages are applied to the SBG electrodes by the voltage source 40 via the electrical contacts 42. In one embodiment of the invention the orientations of the grating vectors are random. FIG. 3 shows the grating element 34 in its active state under an applied voltage V2 while FIG. 4 show the grating element 35 in its active state under an applied voltage V3. The incident, diffracted and zero order beams are indicted by 110,105,106 respectively in FIG. 3 and by 111,107,108 respectively in FIG. 3 The electrodes to which voltages are supplied are indicated by black shading. In the case of FIG. 3 electrode element 34 and the common electrode 32 are selected. In the case of FIG. 3 electrode element 34 and the common electrode 32 are selected by the voltage source. The invention does not assume any particular array geometry. The array may be one dimensional or two dimensional.

In one embodiment of the invention also represented by FIGS. 3-4 the electrodes may used to provide spatially varying index modulation across the hologram both vertically and horizontally.

The array may be similar to the ones used in the DigiLens disclosed in U.S. Provisional Patent Application No. 61/627,202 filed on 7 Oct. 2011, entitled WIDE ANGLE COLOUR HEAD MOUNTED DISPLAY and U.S. Provisional Patent Application No. 61/687,436 filed on 25 Apr. 2012, entitled IMPROVEMENTS TO HOLOGRAPHIC WIDE ANGLE DISPLAYS which are both incorporated by reference herein in their entireties. The electrodes may be patterned according to the teachings of PCT US2006/043938 with filing date 13 Nov. 2006 entitled METHOD AND APPARATUS FOR PROVIDING A TRANSPARENT DISPLAY and PCT Application No.: US2008/001909, with International Filing Date: 22 Jul. 2008, entitled LASER ILLUMINATION DEVICE which are both incorporated by reference herein in their entireties.

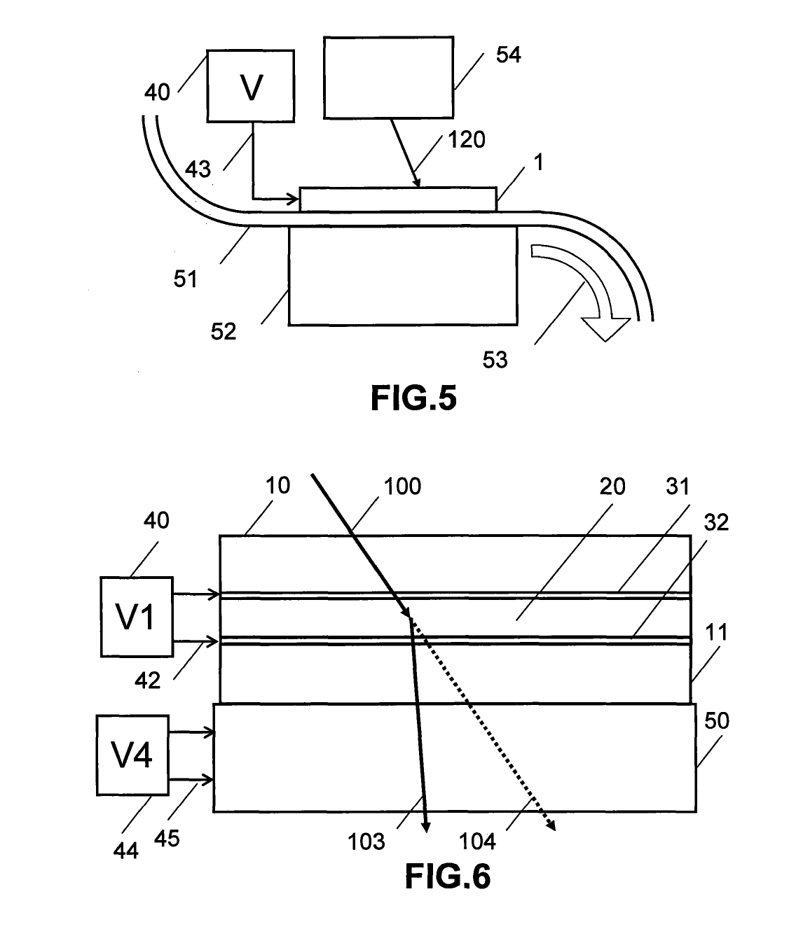

FIG. 5 is a schematic illustration of a hologram replication apparatus based on any of the above embodiments of the invention. The apparatus comprises the master hologram 11, a laser module 54 for providing a beam of light which will typically be collimated, a voltage source 40 couple to the electrodes of the master hologram by electrical connections generally indicated by 45, a sheet of holographic recording film 51 which is translated across the aperture of the master hologram in stepwise fashion in the direction indicated by the block arrow 53, and a platform or stage 52 for supporting the master and copy holograms. The platform 52 will typically comprise a rigid holder for securing the master, a track for guiding the moving copy hologram and a cavity or filters for trapping stray light that may otherwise interfere with the holographic replication process. Other features that may be provided in the platform 52 will be apparent to those skilled in the art. In one embodiment of the invention the holographic recording film is a HPDLC mixture sandwiched between thin plastic substrates to which flexible transparent electrodes have been applied. Typically the substrates are 100 microns in thickness. The embodiment of FIG. 5 may be used in a roll-to-roll hologram fabrication process.

FIG. 6 is a schematic view of an apparatus for replicating SBGs based on the above described master holograms. The key feature of this embodiment is that a further voltage source 44 is used to apply a voltage V4 to the copy SBG 50 via the electrical contacts 45 during the replication process. The embodiment of FIG. 6 has the advantage of providing tighter control of the modulation of the copy hologram.

The present invention does not assume that any particular holographic recording process or HPDLC material is used to fabricate the SBG master hologram. Any of the processes and material systems currently used to fabricate SBGs may be used such as for example the ones disclosed in U.S. Pat. No.5, 942,157 by Sutherland, and U.S. Pat. No. 5,751,452 by Tanaka. The master may be recorded using currently available industrial processes such as the ones provided by companies such as Holographix LLC (MA). Ideally, the master would be recorded using remote computer controlled equipment, which by removing human presence eliminates vibrations and thermal variations that may adversely affect the quality of the recording process. Ideally, the master recording laboratory should be protected from vibrations from external disturbances. Desirably, the master hologram recording equipment will provide active fringe stabilization.

In the preferred embodiment the SBG master hologram operates in reverse mode such the hologram diffracts when a voltage is applied and remains optically passive at all other times. A reverse mode SBG will provide lower power consumption. A reverse mode HPDLC and methods for fabricating reverse mode SBG devices is disclosed in U.S. Provisional Patent Application No. 61/573,066. with filing date 24 Aug. 2011 by the present inventors entitled IMPROVEMENTS TO HOLOGRAPHIC POLYMER DISPERSED LIQUID CRYSTAL MATERIALS AND which is incorporated by reference herein in its entirety. Ultimately, the inventors aim to make replica SBGs with plastic substrates and flexible transparent conductive coatings (to replace ITO). Plastic SBG technology suitable for the present invention is also disclosed in U.S. Provisional Patent Application No. 61/573,066. A reverse mode SBG is more ideally suited to mastering as it avoids the degradation of SBG material that occurs with UV recording.

Advantageously, the SBG master will used thin flexible glass substrates such as the ones developed by Corning and Schott driven by the touch panel and smart phone industries. Thinner optical substrates will allow better optical interfacing of the SBG master hologram plane to the copy hologram.

It should be understood by those skilled in the art that while the present invention has been described with reference to exemplary embodiments, it is to be understood that the invention is not limited to the disclosed exemplary embodiments. Various modifications, combinations, sub-combinations and alterations may occur depending on design requirements and other factors insofar as they are within the scope of the appended claims or the equivalents thereof.

1. A holographic recording apparatus comprising:
a source of illumination;
a master hologram containing at least one hologram lamina overlaying;
a copy substrate containing a holographic recording medium; and
a voltage generator for applied a voltage across at least one of said master hologram and said copy substrate;
said master hologram diffracting said illumination into zero order light and diffracted light, said zero order light and diffracted light interfering in said copy substrate to form a copy of said master hologram,
said source of illumination being applied for a predefined exposure time,
wherein said voltage varies the refractive index modulation of at least one of said master hologram and said copy hologram during said exposure time.

2. The apparatus of claim 1 wherein said voltage spatially varies said refractive index modulation.

3. The apparatus of claim 1 wherein said master hologram is one of a photo thermal refractive or photopolymer, a forward mode SBG or a reverse mode SBG.

4. The apparatus of claim 1 wherein said master hologram is a SBG comprising transparent plates to which electrodes coupled to said voltage generator have been applied, said plates sandwiching a layer containing HPDLC material components.

5. The apparatus of claim 1 wherein said master hologram comprises a multiplicity of electrically addressable SBG lamina.

6. The apparatus of claim 1 wherein said at least one hologram lamina has a grating vector selected from a predefined set of grating vectors.

7. The apparatus of claim 1 wherein said at least one hologram lamina has a grating vector selected from a predefined set of randomly orientated grating vectors

8. The apparatus of claim 1 wherein said at least one hologram lamina has spatially varying grating vector.

9. The apparatus of claim 1 wherein said holographic recording medium comprises HPDLC material components for forming one of a forward mode SBG or a reverse mode SBG.

10. The apparatus of claim 1 wherein said zero order light and diffracted light have power substantially in the ratio of 1:1.

11. The apparatus of claim 1 wherein said copy substrate is fabricated from optical plastic.

12. The apparatus of claim 1 wherein said master hologram and said copy substrate are separated by an air gap.

13. The apparatus of claim 1 wherein said master hologram and said copy substrate are in contact.

14. The apparatus of claim 1 wherein said copy substrate forms part of a mechanically translatable continuous lamina.
